(19) United States
(12) Patent Application Publication
(10) Pub. No.: US 2011/0020044 A1
(43) Pub. Date: Jan. 27, 2011

(54) PRINTING MEDIUM CLAMP MECHANISM OF BARCODE PRINTER

(75) Inventor: I-CHE YU, I-LAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: TSC AUTO ID TECHNOLOGY CO., LTD., TAIPEI CITY (TW)

(21) Appl. No.: 12/788,791

(22) Filed: May 27, 2010

(30) Foreign Application Priority Data
Jul. 22, 2009 (TW) 098213350

(51) Int. Cl. B41J 15/02

(52) U.S. Cl. 400/613

(57) ABSTRACT

A printing medium clamp mechanism is provided for use in a barcode printer and includes a housing, at least one swivel arm, at least one resilient element, at least one medium roll clamps, and at least two movable arms. The housing comprises an inner casing arranged therein. The inner casing forms two through slots serving as tracks. The swivel arm is rotatably mounted to a bottom of the inner casing. The resilient element is connected between an end of the swivel arm and the inner casing to provide a biasing force for return rotation of the swivel arm. The medium roll clamps are respectively and movably received in the tracks. The two movable arms have first ends coupled to opposite ends of the swivel arm and opposite, second ends coupled to the medium roll clamps respectively, whereby the two medium roll clamps are coupled in a resilient manner to the swivel arms to be movable along the tracks of the inner casing for outward movement of separating from each other or inward movement of approaching each other and effecting clamping of a roll of printing medium. In this way, when the medium roll clamps are forced to outward move against the resilient biasing force, a roll of printing medium can be received and installed; and when the medium roll clamps are released, they are biased to return and clamp the roll of the printing medium. As such, a printing medium clamp mechanism featuring a resilient returning and clamping force for clamping a roll of printing medium is provided.

### BACKGROUND OF THE INVENTION

1. Field of the Invention

The present invention relates to a printing medium clamp mechanism of a barcode printer, and in particular to a mechanism that comprises medium roll clamps that are set in driving and spring-biased coupling with a swivel arm and movable arms to provide the medium roll clamps with a biasing force for securely clamping a roll of printing medium.

2. The Related Arts

In a conventional barcode printer, a roll of printing labels is received and retained inside the barcode printer to supply the printing labels to a printing mechanism for effecting printing on the labels. The roll is supported and retained by a clamp mechanism that only works for clamping label rolls of a fixed length and diameter and is not capable of accommodating label rolls of various widths or lengths. This adversely affects the development of the barcode printer industry. Further, the label roll cannot be securely held inside the barcode printer, thereby affecting the printing quality realized through the barcode printer.

To cope with the above mentioned problems in respect of securely clamping a roll of label inside a barcode printer to effect high quality printing, various solutions have been proposed. For example, U.S. Pat. No. 5,813,343 disclosed a printing media roll mounting and position mechanism, which provides a solution adopting engagement between a gear and a rack. A spring is connected between the rack and a housing of the printers to provide a spring force acting upon the rack. Through guidance realized through the engagement between the gear and the rack, a mechanism may be formed to selectively clamp or release a roll of printing labels.

The mechanism proposed by the above-mentioned U.S. Pat. No. 5,813,343 uses a spring force to clamp/release and mount printing label roll in a printer. A disadvantage is that the engagement between rack and gear makes assembling complicated and high cost and may cause wear between the rack and gear that leads to constantly generated error between the label roll clamp mechanism and a roll of labels and insufficient clamping force. Consequently, mounting a label roll becomes troublesome and problematic.

### SUMMARY OF THE INVENTION

The known medium roll clamp mechanism is incapable to properly clamp printing medium rolls of various widths and lengths or may lead to high costs and inconvenient operation of mounting a medium roll due to positing and retaining the medium roll being realized through engagement between rack and gear and deficiency of mechanical failure due to wear between the gear and the rack.

To overcome the problems and drawbacks of the conventional devices, the present invention provides a printing medium clamp mechanism for use in a barcode printer and comprising a housing, at least one swivel arm, at least one resilient element, at least one medium roll clamps, and at least two movable arms. The housing comprises an inner casing arranged therein. The inner casing forms two through slots serving as tracks. The swivel arm is rotatably mounted to a bottom of the inner casing. The resilient element is connected between an end of the swivel arm and the inner casing to provide a biasing force for return rotation of the swivel arm. The medium roll clamps are respectively and movably received in the tracks. The two movable arms have first ends coupled to opposite ends of the swivel arm and opposite, second ends coupled to the medium roll clamps respectively, whereby the two medium roll clamps are coupled in a resilient manner to the swivel arms to be movable along the tracks of the inner casing for outward movement of separating from each other or inward movement of approaching each other and effecting clamping of a roll of printing medium. In this way, when the medium roll clamps are forced to outward move against the resilient biasing force, a roll of printing medium can be received and installed; and when the medium roll clamps are released, they are biased to return and clamp the roll of the printing medium. As such, a printing medium clamp mechanism featuring a resilient returning and clamping force for clamping a roll of printing medium is provided.

The efficacy of the printing medium clamp mechanism of the present invention is that a simple construction formed by a swivel arm, a resilient element, two medium roll clamps, and two movable arms is capable of accommodating rolls of printing medium of various lengths or widths in a securely clamped manner inside a barcode printer. Problems caused by wear between engaged parts are eliminated to thereby enhance convenience and reliability of installing a roll of printing medium in a barcode printer.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a printing medium clamp mechanism constructed in accordance with an embodiment of the present invention;

FIG. 2 is an exploded view of the printing medium clamp mechanism of the present invention;

FIG. 3 is also an exploded view of the printing medium clamp mechanism of the present invention, taken from a different perspective;

FIG. 4 is a bottom view of the printing medium clamp mechanism of the present invention;

FIG. 5 is a perspective view illustrating an application of the printing medium clamp mechanism of the present invention;

FIG. 6 is a top view illustrating an operation of outward moving and thus spacing two medium roll clamps of the printing medium clamp mechanism of the present invention away from each other to accommodate a roll of printing medium therebetween;

FIG. 7 is a bottom view illustrating the outward movement of the medium roll clamps drives operations of a swivel arm, a resilient element, and two arms in order to clamp the roll of printing medium;

FIG. 8 is a top view illustrating inward movement of the two medium roll clamps of the printing medium clamp mechanism of the present invention to securely clamp and hold the roll of printing medium therebetween; and

FIG. 9 is a bottom view showing a printing medium clamp mechanism constructed in accordance with another embodiment of the present invention.

### DETAILED DESCRIPTION OF THE PREFERRED EMBODIMENTS

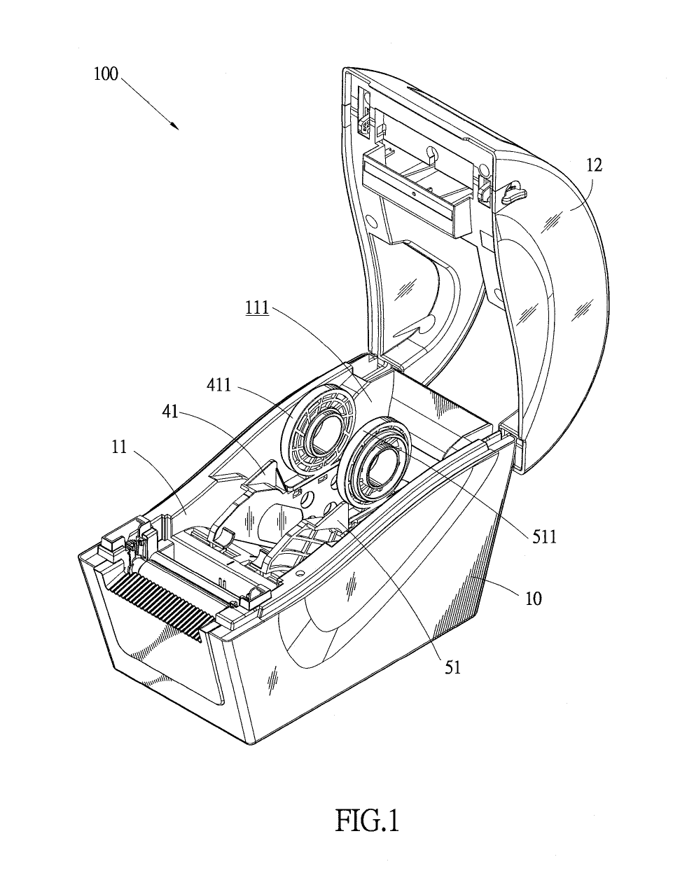

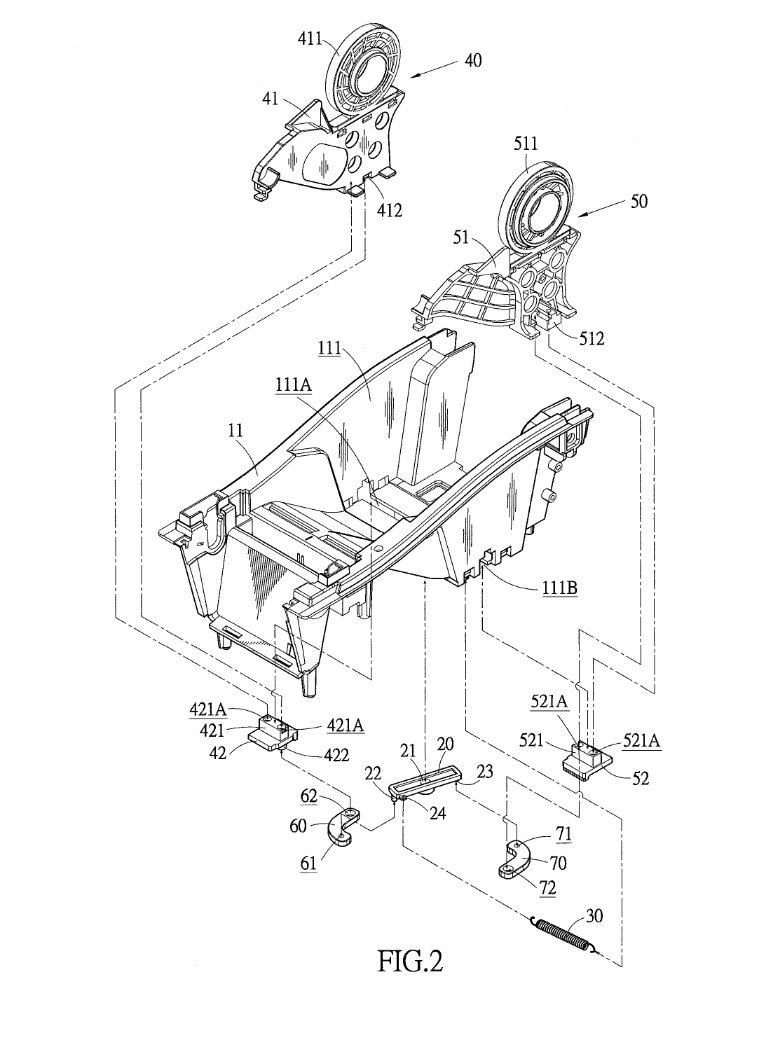

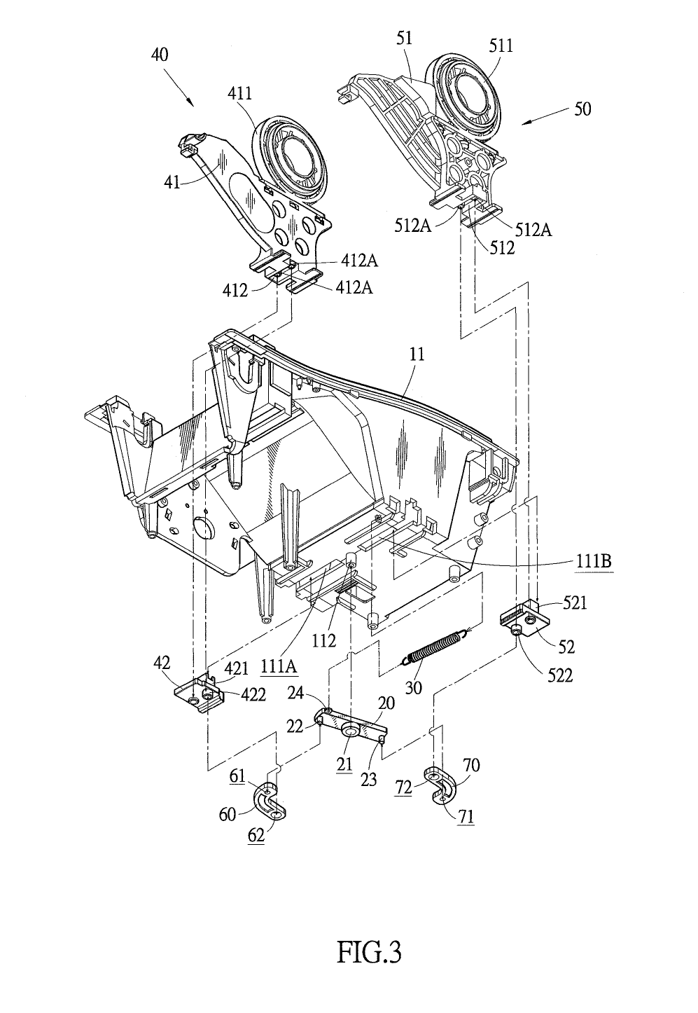

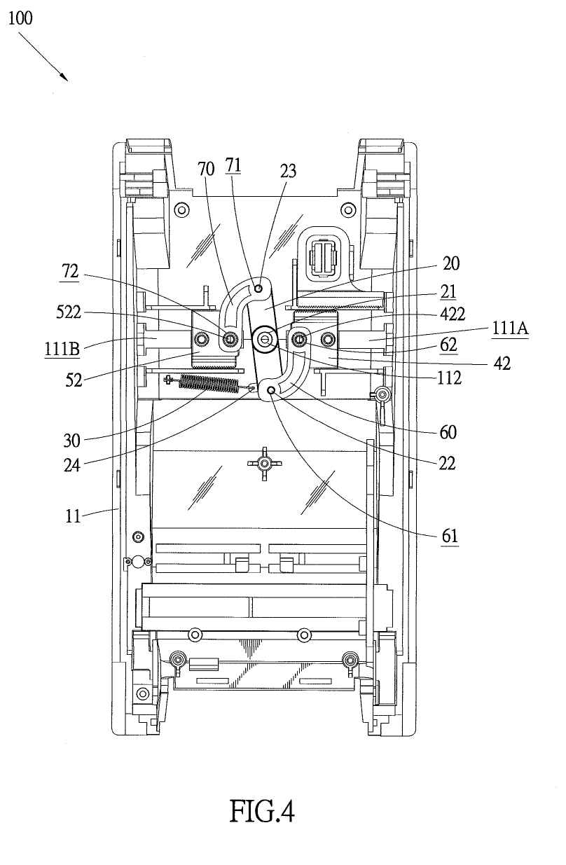

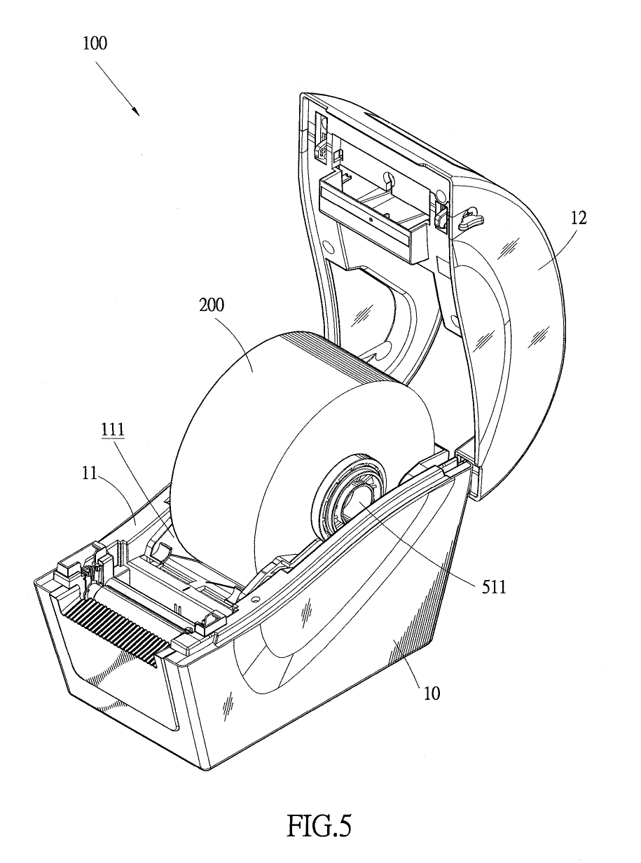

With reference to the drawings and in particular to FIGS. 1-4, a printing medium clamp mechanism constructed in accordance with the present invention, generally designated with reference numeral 100, is shown for use in a barcode printer to securely and stably hold a roll of printing medium 200 (see FIG. 5). The printing medium clamp mechanism 100 comprises a housing 10 and an inner casing 11 formed inside the housing 10. The inner casing 11 defines a medium roll accommodation compartment 111. The medium roll accommodation compartment 111 has a bottom wall (not labeled) that forms at least two slide tracks 111A, 111B, preferably linear and aligning but spaced from each other. The underside of the bottom wall of the inner casing 11 forms a shaft 112. A cover 12 is pivotally connected to a rear side of the housing 10 in such a way that the cover 12 is allowed to close down over the medium roll accommodation compartment 111 of the inner casing 11 or may selectively lifted for opening.

At least one swivel arm 20 forms a joint hole 21. The joint hole 21 is rotatably coupled to the shaft 112 on the underside of the bottom wall of the inner casing 11 of the housing 10. In the instant preferred embodiment illustrated, the swivel arm 20 is set midway between the tracks 111A, 111B. Thus, the swivel arm 20 is rotatable about the shaft 112. The swivel arm 20 has two opposite ends respectively forming a pin 22, 23 and also forms a connection section 24 adjacent one of the ends.

At least one resilient element 30 has an end attached to the bottom wall of the inner casing 11 of the housing 10 and an opposite end attached to the connection section 24 of the swivel arm 20, whereby the swivel arm 20 is acted upon by a biasing force of the resilient element 30 to realize biased rotation. The resilient element 30 is not limited to any specific type and a spring is used as an example in the embodiment illustrated. It is apparent that other resilient elements/device exhibiting an equivalent function is considered an equivalent replacement of the resilient element 30 and is considered within the scope of the present invention.

At least two medium roll clamps 40, 50 are provided to respectively correspond to the tracks 111A, 1118. Each medium roll clamp 40, 50 comprises at least one medium roll support 41, 51 and at least one slide 42, 52. The medium roll support 41, 51 has a top forming a clamping block 411, 511 and a bottom forming a fitting section 412, 512, which is in the form of a recess in which a pair of pegs 412A, 512A is formed. The slide 42, 52 has a top forming at least one jointing section 421, 521 in the form of a raised block, which forms at least a pair of holes 421A, 521A. The jointing section 421, 521 is received, from the underside of the bottom wall of the inner casing 11 of the housing 10, through the respective track 111A, 111B, which is in the form of a slot through the bottom wall of the inner casing 11 of the housing 10, and fit into the fitting section 412, 512 defined in the bottom of the medium roll support 41, 51, whereby the pegs 412A, 512A are received into the holes 421A, 521A of the slide 42, 52 to slidably mount the slide 42, 52 to the respectively track 111A, 111B. Consequently, the medium roll support 41, 51 is allowed to move inward and/or outward with respect to the inner casing 11 of the housing 10 along the respectively track 111A, 111B. Each slide 42, 52 has a bottom forming at least one connection pin 422, 522.

At least two movable arms 60, 70 are provided and each movable arm 60, 70 has two opposite ends respectively forming a first connection hole 61, 71 and a second connection hole 62, 72. The first connection holes 61, 71 of the two movable arms 60, 70 respectively correspond to and pivotally joint to the pins 22, 23 on the opposite ends of the swivel arm 20. The second connection holes 62, 72 respectively correspond to and pivotally joint to the connection pins 422, 522 on the bottom of the slides 42, 52. Thus, the swivel arm 20, the slides 42, 52, and the movable arms 60, 70 respectively form a driving coupling featuring resiliently biased returning.

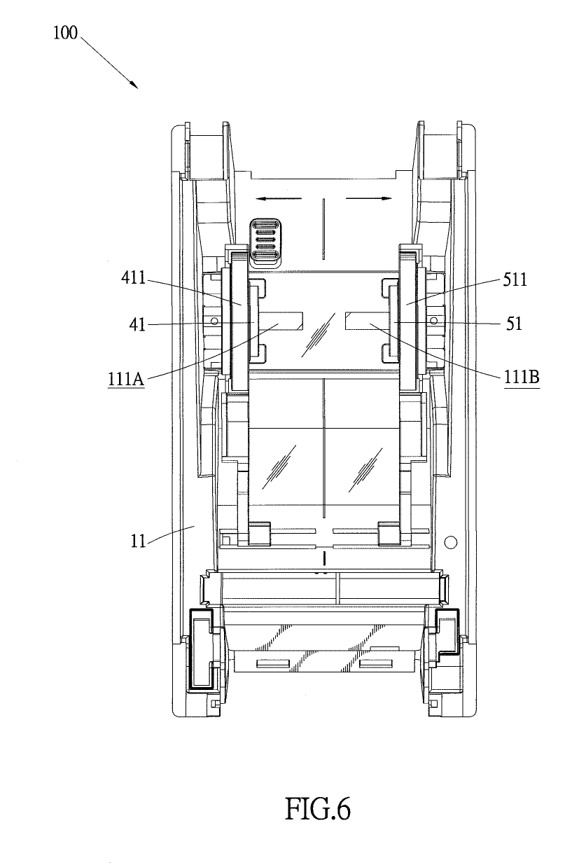

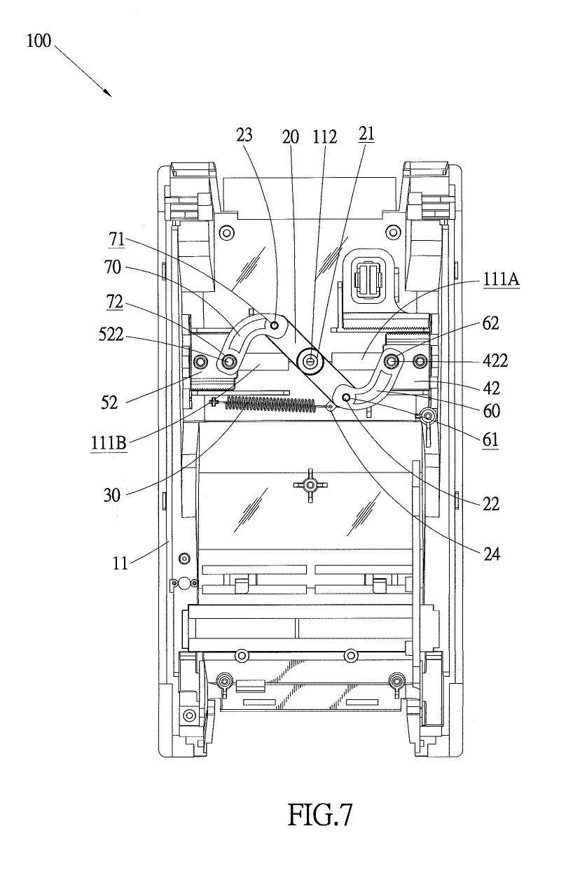

Referring to FIGS. 5-8, an application of the printing medium clamp mechanism 100 of the present invention is illustrated. To clamp a printing medium 200, the medium roll supports 41, 51 of the medium roll clamps 40, 50 are moved outward along the tracks 111A, 111B of the inner casing 11 of the housing 10 (as indicated by arrows shown in FIG. 6), to have the two medium roll supports 41, 51 spaced from each by a sufficient distance to receive a roll of printing medium 200 therebetween. Due to the coupling between the slides 42, 52 and the movable arms 60, 70, which cause rotation of the swivel arm 20 in a given direction, the resilient element 30 is deformed and set in a condition of for example tension to apply a returning biasing force to the swivel arm 20. The clamping blocks 411, 511 on the top of the medium roll supports 41, 51 are now positioned at opposite ends of the roll of printing medium 200.

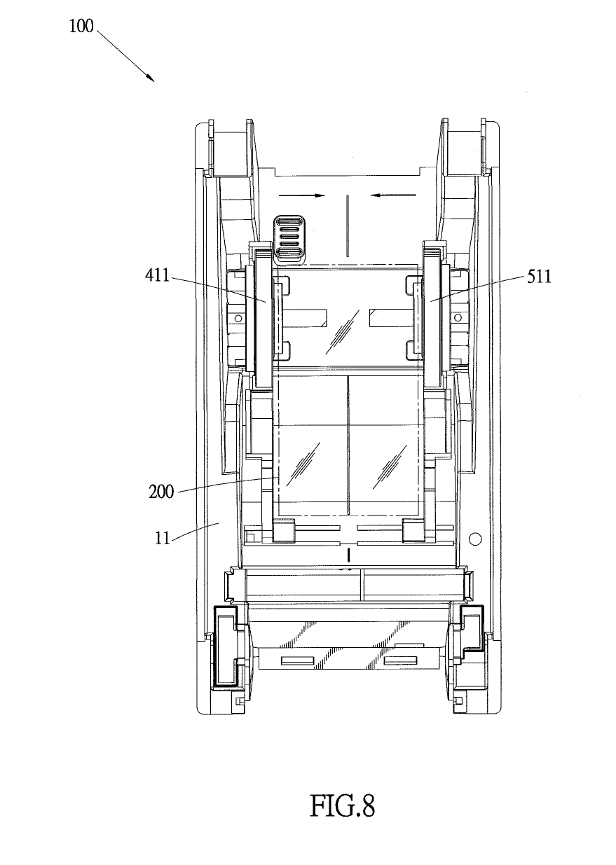

With the opposite ends of the roll of the printing medium 200 properly set to correspond to the clamping blocks 411, 511 of the medium roll supports 41, 51, by releasing the medium roll supports 41, 51, the swivel arm 20, which is acted upon by the returning biasing force of the resilient element 30, is allowed to rotate in an opposite direction and due to the coupling among the swivel arm 20, the movable arms 60, 70, and the slides 42, 52, the medium roll supports 41, 51 are caused to move inward along the tracks 111A, 111B to tightly position the clamping blocks 411, 511 on the tops of the medium roll supports 41, 51 against the ends of the roll of printing medium 200 (as indicated by the arrows of FIG. 8). Easy mounting of the roll of printing medium 200 is thus realized. To remove a used-up roll of printing medium 200, the same process is carried out in a reversed sequence and afterwards, a new roll of printing medium 200 can be installed again.

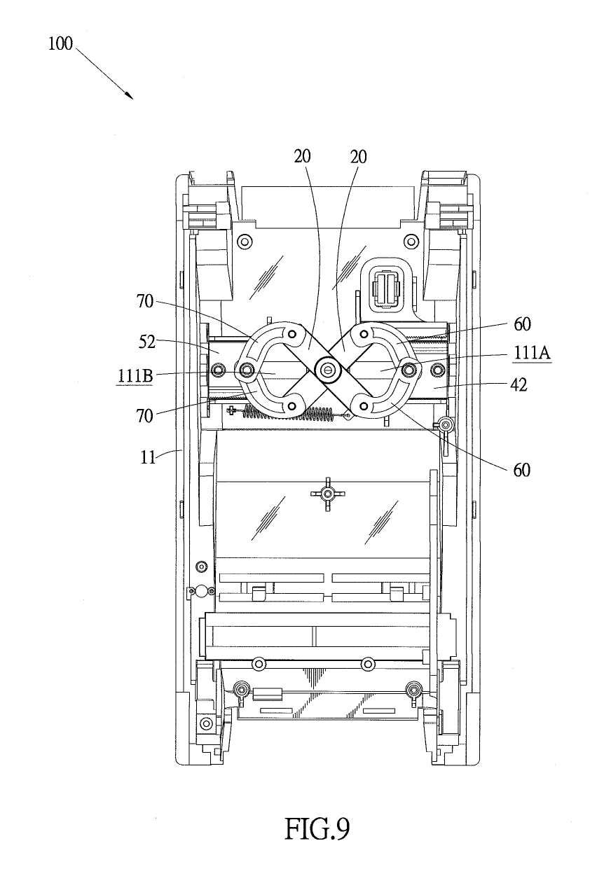

Referring to FIG. 9, a printing medium clamp mechanism in accordance with another embodiment of the present invention is shown, also designated with reference numeral 100 for simplicity. The another embodiment of the printing medium clamp mechanism 100 comprises two swivel arms 20, which are set in a cross form to intersect each other substantially midways and each is associated with two arms 60, 70 to pivotally couple with the slides 42, 52 of the medium roll clamps 40, 50 for selectively moving the medium roll supports 41, 51 of the medium roll clamps 40, 50 inward and/or outward for installing/removing a roll of printing medium 200 in a smoother and more balanced manner.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A printing medium clamp mechanism for use in a barcode printer, comprising:
at least a housing inside which an inner casing is arranged, the inner casing defining a medium roll accommodation compartment and having a bottom wall forming at least two tracks;
at least one swivel arm, which is coupled to the bottom of the inner casing to be rotatable;
at least one resilient element, which has an end attached to the bottom of the inner casing and an opposite end attached to an end of the swivel arm to provide biased rotation of the swivel arm;
at least two medium roll clamps, which are respectively and movably received in the tracks of the inner casing to allow the medium roll clamps to selectively move inward and outward with respect to the inner casing along the tracks; and
at least two movable arms, each of which has an end corresponding to and pivotally jointing to a respective one of two opposite ends of the swivel arm and an opposite end corresponding to and pivotally jointing to bottoms of the two medium roll clamps, the swivel arm forming a driving coupling with each of the medium roll clamps and the respective arm in a resilient biased returning manner, whereby the medium roll clamps are forcibly movable outward to space from each other for accommodating a roll of printing medium therebetween and the medium roll clamps are resiliently biased to return for securely clamping opposite ends of the roll.

2. The printing medium clamp mechanism as claimed in claim 1, wherein the bottom of the inner casing forms a shaft and wherein the swivel arm forms a joint hole rotatably coupled to the shaft.

3. The printing medium clamp mechanism as claimed in claim 1, wherein the swivel arm forms a connection section to which an end of the resilient element is attached.

4. The printing medium clamp mechanism as claimed in claim 1, wherein the two ends of the swivel arm respectively form a pin.

5. The printing medium clamp mechanism as claimed in claim 1, wherein the resilient element comprises a spring.

6. The printing medium clamp mechanism as claimed in claim 1, wherein each medium roll clamp comprises:
at least one medium roll support, which has a bottom forming a fitting recess, in which two pegs are formed; and
at least one slide, which has a top forming at least one raised jointing section, in which two holes are defined, the jointing section extending through the respective track and fit into the fitting recess of the medium roll support to have the pegs respectively received in the holes, whereby the slide is slidably mounted to the track to allow for selective inward and outward movement of the medium roll support along the track through the slide.

7. The printing medium clamp mechanism as claimed in claim 6, wherein the medium roll support has a top forming a clamping block.

8. The printing medium clamp mechanism as claimed in claim 6, wherein the slide has a bottom forming at least one connection pin.

9. The printing medium clamp mechanism as claimed in claim 1, wherein each of the movable arms has an end forming a first connection hole.

10. The printing medium clamp mechanism as claimed in claim 1, wherein each of the movable arms has an opposite end forming a second connection hole.
